(19) United States
(12) Patent Application Publication
(10) Pub. No.: US 2014/0032178 A1
(43) Pub. Date: Jan. 30, 2014

(54) SYSTEMS AND METHODS FOR SOLAR PHOTOVOLTAIC DESIGN

(71) Applicants: Maciej Kicinski, Santa Clara, CA (US); Travis Z. Brier, San Francisco, CA (US); Peter Rive, San Francisco, CA (US)

(72) Inventors: Maciej Kicinski, Santa Clara, CA (US); Travis Z. Brier, San Francisco, CA (US); Peter Rive, San Francisco, CA (US)

(73) Assignee: SOLARCITY CORPORATION, San Mateo, CA (US)

(21) Appl. No.: 13/557,450

(22) Filed: Jul. 25, 2012

(51) Int. Cl. G06F 17/50

(52) U.S. Cl. 703/1

(57) ABSTRACT

Systems and methods for designing a solar photovoltaic (PV) system. In one embodiment, a method is provided that can comprise retrieving an image of a site where a PV system is to be installed. The method can further comprise receiving, from a user, a definition of a mounting plane for mounting one or more PV panels at the site, and automatically determining a configuration of PV panels that fits on the mounting plane. The configuration of PV panels can then be displayed to the user such that the configuration is superimposed on the site image.

### BACKGROUND

The present disclosure relates in general to solar photovoltaic (PV) systems, and in particular to PV system design.

In recent years, climate change concerns, federal/state initiatives, and other factors have driven a rapid rise in the demand for PV systems at residential and non-residential sites. A conventional PV system comprises one or more PV panels and a power inverter. The PV panels, which convert sunlight into electricity, are typically linked together into one or more strings. The strings are then connected to the power inverter, which converts the direct current (DC) power generated by the strings into alternating current (AC) power that can be used by site loads or fed into the utility grid. Since the overall power output of the system is directly correlated to the amount of sunlight received by the PV panels, the panels generally should be mounted at the installation site in a manner that maximizes their exposure to the sun throughout the year.

Currently, the process of designing the layout and configuration of PV panels for a proposed PV system requires an auditor to physically visit the installation site in order to determine various site parameters (e.g., amount of available roof space for mounting, nearby obstructions that may result in panel shading, etc.). This can be time-consuming and cumbersome, particularly for high volume system vendors/installers. Further, for a given PV panel configuration, there is no way to easily visualize what the site will look like post-installation, or to generate a quick estimate of the yearly PV energy production for the configuration. These may be important considerations for the site owner when deciding whether to move forward with the installation. Accordingly, it would be desirable to have a computer-implemented tool that addresses these and other similar issues.

### SUMMARY

Embodiments of the present invention relate to systems and methods for designing a solar photovoltaic (PV) system. According to one embodiment, a method is provided that can comprise retrieving an image of a site where a PV system is to be installed. The method can further comprise receiving, from a user, a definition of a mounting plane for mounting one or more PV panels at the site, and automatically determining a configuration of PV panels that fits on the mounting plane. The configuration of PV panels can then be displayed to the user such that the configuration is superimposed on the site image.

In one embodiment, the image of the site can be a satellite or aerial image.

In one embodiment, retrieving the image of the site can comprise retrieving a first image of the site from a first web-based mapping service, retrieving a second image of the site from a second web-based mapping service, and displaying, to the user, the first image and the second image. A selection of the first image or the second image can then be received from the user.

In one embodiment, the definition of the mounting plane can include a plurality of points defining a polygon, where the polygon has been drawn on the image by the user.

In one embodiment, the site can be a residence or a building, where the polygon has been drawn on a roof surface of the residence or building.

In one embodiment, automatically determining the configuration of PV panels that fits on the mounting plane can comprise receiving, from the user, a selection of a PV panel type; determining, based on the selected PV panel type, a PV panel size; calculating an actual area of the mounting plane, the calculating taking into account the heading and elevation at which the image of the site was taken; and filling in the mounting plane with PV panels based on the PV panel size and the actual area of the mounting plane.

In one embodiment, the method can further comprise, subsequently to automatically determining the configuration of PV panels, automatically calculating a stringing solution for the PV panels.

In one embodiment, automatically calculating the stringing solution can comprise receiving, from the user, a selection of a PV inverter manufacturer and dividing the PV panels into one or more groups. The method can further comprise, for each group, selecting the largest capacity PV inverter available from the manufacturer and calculating a set of strings compatible with the selected inverter. The calculating can be performed such that a maximum number of PV panels from the group are included. If, subsequently to calculating the set of strings, there are no remaining PV panels in the group that are not in the set of strings, a smaller capacity PV inverter available from the manufacturer can be selected and a determination can be made whether the smaller capacity PV inverter can accommodate that set of strings. Else, the previous selecting and calculating steps can be repeated for the remaining PV panels in the group.

In one embodiment, calculating the set of strings can comprise performing a string-level shading analysis and a panel-level shading analysis. The set of strings can then be calculated based on the string-level and panel-level (or sub-panel-level) analyses.

In one embodiment, the method can further comprise receiving, from the user, definitions of one or more obstructions at the site, calculating production estimates for the PV panels in the configuration of PV panels in view of the one or more obstructions, and providing a visual representation of the production estimates.

In one embodiment, providing a visual representation of the production estimates can comprise color-coding the PV panels based on the production estimates.

In one embodiment, the one or more obstructions can be predefined three-dimensional (3D) objects selected from a 3D object library.

In one embodiment, each 3D object in the 3D object library can be stored as a cascading series of three-dimensional or two-dimensional objects.

In one embodiment, calculating production estimates for the PV panels can comprise calculating yearly sun exposure values for the PV panels, calculating yearly production values for the PV panels, and modifying the yearly production values by the yearly sun exposure values to determine the production estimates.

In one embodiment, calculating the yearly sun exposure values can comprise, for each obstruction in the one or more obstructions, determining a shadow path created by the obstruction over the mounting plane throughout a year. The method can further comprise, for each PV panel, determining, based on the shadow paths, how often the PV panel (or portions thereof) would be shaded throughout the year.

In another embodiment, calculating the yearly sun exposure values can comprise, for each PV panel, simulating rays between the sun's position and the PV panel throughout a year; determining whether the rays are blocked by any obstructions before reaching the PV panel; and calculating the yearly sun exposure value for the PV panel based on the number of blocked and unblocked rays.

In yet another embodiment, calculating the yearly sun exposure values can comprise, for each PV panel, simulating rays between the sun's position and the PV panel throughout a year; calculating a Total Solar Resource Fraction (TSRF) value for the PV panel based on the rays; and calculating a yearly sun exposure value for the PV panel based on the TSRF value.

In one embodiment, the yearly production values can be calculated without using any historical production data.

According to another embodiment of the present invention, a non-transitory computer-readable storage medium having stored thereon program code executable by a computer system is provided. The program code can comprise code that causes the computer system to retrieve an image of a site where a PV system is to be installed; code that causes the computer system to receive, from a user, a definition of a mounting plane at the site, the mounting plane representing a plane for mounting one or more PV panels of the PV system; code that causes the computer system to automatically determine a configuration of PV panels that fits on the mounting plane; and code that causes the computer system to display the configuration of PV panels such that the configuration is superimposed on the site image.

According to yet another embodiment of the present invention, a system comprising a processor is provided. The processor can be configured to retrieve an image of a site where a PV system is to be installed; receive, from a user, a definition of a mounting plane at the site, the mounting plane representing a plane for mounting one or more PV panels of the PV system; automatically determine a configuration of PV panels that fits on the mounting plane; and display the configuration of PV panels such that the configuration is superimposed on the site image.

A further understanding of the nature and advantages of the embodiments disclosed herein can be realized by reference to the remaining portions of the specification and the attached drawings.

### BRIEF DESCRIPTION OF THE DRAWINGS

FIG. 1 is a simplified block diagram of a system environment in accordance with an embodiment of the present invention.

FIG. 2 is a simplified block diagram of a computer system in accordance with an embodiment of the present invention.

FIG. 3 is a flow diagram of a process for designing a PV system in accordance with an embodiment of the present invention.

FIG. 4 is an example graphical user interface for retrieving an image of an installation site in accordance with an embodiment of the present invention.

FIG. 5 is an example graphical user interface depicting a retrieved site image in accordance with an embodiment of the present invention.

FIG. 6 is an example graphical user interface for comparing retrieved site images in accordance with an embodiment of the present invention.

FIG. 7 is an example graphical user interface for entering a definition of a mounting plane in accordance with an embodiment of the present invention.

FIG. 8 is an example graphical user interface depicting a configuration of PV panels that have been added to a user-defined mounting plane in accordance with an embodiment of the present invention.

FIG. 9 is a flow diagram of a process for calculating an actual area of a user-defined mounting plane in accordance with an embodiment of the present invention.

FIGS. 10A-10D are images illustrating how an example mounting plane may be filled in with PV panels in accordance with an embodiment of the present invention.

FIG. 11 is a flow diagram of a process for determining a stringing solution for a configuration of PV panels in accordance with an embodiment of the present invention.

FIG. 12 is an example graphical user interface for entering PV panel and PV inverter information in accordance with an embodiment of the present invention.

FIG. 13 is an example graphical user interface for entering definitions of one or more obstructions in accordance with an embodiment of the present invention.

FIGS. 14A and 14B are representations of an example 3D object in accordance with an embodiment of the present invention.

FIG. 15 is a flow diagram of a process for calculating PV panel production estimates in accordance with an embodiment of the present invention.

FIG. 16 is an example graphical user interface depicting a configuration of PV panels that have been color-coded based on calculated production estimates in accordance with an embodiment of the present invention.

FIG. 17 is a flow diagram of a first process for calculating yearly sun exposure values for a configuration of PV panels in accordance with an embodiment of the present invention.

FIG. 18 is a diagram illustrating calculated shadow paths for an obstruction in accordance with an embodiment of the present invention.

FIG. 19 is a flow diagram of a second process for calculating yearly sun exposure values for a configuration of PV panels in accordance with an embodiment of the present invention.

FIG. 20 is a diagram illustrating calculated sun rays for a PV panel in accordance with an embodiment of the present invention.

FIG. 21 is a flow diagram of a process for calculating yearly production values for a configuration of PV panels in accordance with an embodiment of the present invention.

### DETAILED DESCRIPTION

In the following description, for purposes of explanation, numerous examples and details are set forth in order to provide an understanding of embodiments of the present invention. It will be evident, however, to one skilled in the art that certain embodiments can be practiced without some of these details, or can be practiced with modifications or equivalents thereof.

Embodiments of the present invention provide a computer-implemented tool for quickly designing and visualizing a PV system. In one embodiment, the tool can be implemented as a standalone (e.g., desktop) software application configured to run autonomously on one or more computer devices. In another embodiment, the tool can be implemented as a distributed software application hosted on, e.g., a web or application server. In operation, the tool can retrieve an image of a site where a PV system is to be installed. By way of example, if the site is a residence, this step can comprise retrieving a satellite or aerial image of the residence from a publically accessible mapping service. The tool can then receive, from a user, a definition of one or more mounting planes at the site, and automatically determine a configuration of PV panels that fit within the user-defined mounting planes. For instance, the definition of the mounting planes can be received as a series of points comprising one or more polygons, and the tool can determine the number and layout of PV panels that fit within the areas of the polygons. Once the configuration of PV panels has been determined, the tool can display the determined panel configuration on top of (i.e., superimposed on) the site image.

With the foregoing features, there is no need for a PV system installer to physically visit an installation site in order to design the PV panel layout/configuration for the site. Rather, this design process can be carried out remotely, and various site parameters that are needed for the design (e.g., available mounting space, etc.) can be automatically deduced from the imagery retrieved for the site. In certain embodiments, the tool can also be used on-site by field engineers at an installation site. In addition, by displaying the determined panel configuration on top of the site image, users can envision how the site will look post-installation (i.e., with the PV panels installed). This functionality can be particularly useful for sales staff, as it allows them to quickly and easily generate a visual mock-up of the final, installed system for review by a potential customer.

In further embodiments, the tool can receive definitions of one or more obstructions (e.g., trees, other buildings, etc.) around the installation site. For example, the obstructions can be modeled as three-dimensional objects, and can be selected by a user from a predefined 3D object library. The tool can then run one or more simulations to generate, based on the obstructions, a yearly production estimate for each PV panel in the determined panel configuration. In one embodiment, this simulation can include calculating shadow paths for each obstruction and determining how those shadow paths result in panel shading throughout a year. In another embodiment, this simulation can include performing a raytracing analysis. Once generated, the yearly production estimates can be presented visually in the context of the displayed panel configuration by, e.g., color-coding each PV panel according to its corresponding estimate.

In yet further embodiments, the tool can automatically select certain components of the PV system in view of the determined panel configuration. For example, in one embodiment, the tool can select an optimal PV inverter for the configuration from a range of inverter models available from a selected inverter manufacturer. The tool can also calculate an optimal stringing solution for the PV panels in the configuration based on the selected PV inverter. In certain embodiments, this stringing analysis can take into account some of the panel shading information described above. In situations where the PV panels cannot be completely strung, the tool can automatically remove certain panels from the configuration or indicate to the user that one or more panels need to be removed.

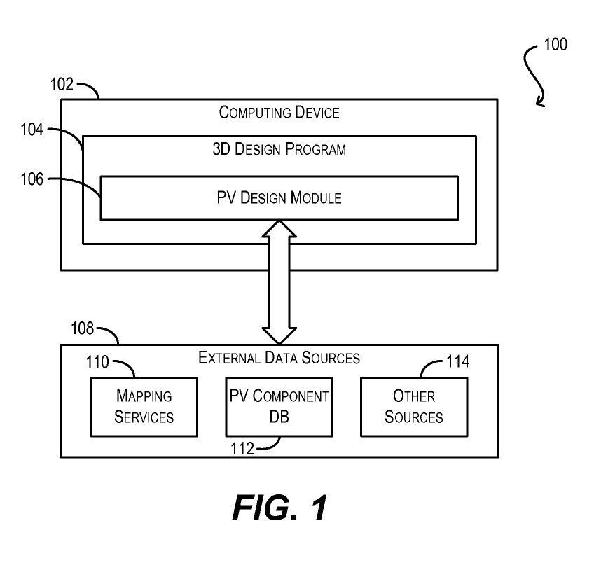

FIG. 1 is a simplified block diagram of a system environment 100 according to an embodiment of the present invention. As shown, system environment 100 includes a computing device 102 configured to execute a three-dimensional (3D) design program 104. Computing device 102 is an end-user computing device, such as a desktop computer, a laptop computer, a personal digital assistant, a smartphone, a tablet, or the like. 3D design program 104 is a software application that enables the creation of 3D content (e.g., models, scenes, etc.). Examples of such programs include Trimble SketchUp, AutoCAD, and the like.

Within the context of a 3D design program 104, computing device 102 is further configured to execute a PV design module 106. In certain embodiments, PV design module 106 can be implemented as an optional plug-in to 3D design program 104. In other embodiments, PV design module 106 can be implemented as an integral component of program 104. PV design module 106 can provide, in conjunction with 3D design program 104, various functions that facilitate the design and visualization of a PV system. For example, in one embodiment, PV design module 106 can retrieve a satellite or aerial image of a site where a PV system is to be installed and allow a user to draw one or more mounting planes on the site image. PV design module 106 can then automatically determine a configuration of PV panels that fit within the user-defined mounting planes and display the determined panel configuration on top of (i.e., superimposed on) the image. In another embodiment, PV design module 106 can allow a user to define 3D obstructions around the installation site (or retrieve definitions of 3D obstructions from an external data source, such as external metadata) and generate, based on the obstructions, a yearly production estimate for each PV panel in the determined panel configuration. In yet another embodiment, PV design module 106 can automatically configure/optimize certain aspects of the PV system installation. For instance, PV design module 106 can automatically select one or more appropriate PV inverters, automatically determine an optimal panel stringing solution, and so on.

As part of its processing, PV design module 106 can interact with one or more external data sources 108 (e.g., mapping services 110, PV component database 112, and other sources 114) to retrieve data used during the design process. For example, PV design module 106 can access mapping services 110 to retrieve satellite/aerial imagery for an installation site. As another example, PV design module 106 can access PV component database 112 to retrieve information regarding PV system components (e.g., PV panels, PV inverters, etc.) that are available for purchase/installation at the site. Although external data sources 108 are depicted as being remote from computing device 102, in certain embodiments one or more of data sources 108 may be stored locally on computing device 102.

It should be appreciated that system environment 100 is illustrative and is not intended to limit embodiments of the present invention. For example, the various entities depicted in system environment 100 can have other capabilities or include other components that are not specifically described. One of ordinary skill in the art will recognize many variations, modifications, and alternatives.

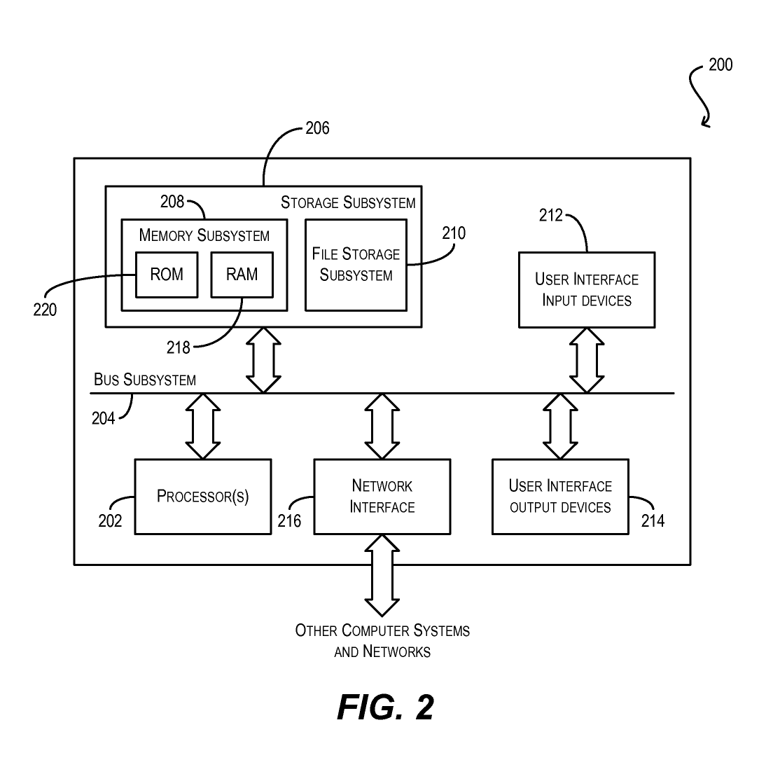

FIG. 2 is a simplified block diagram of a computer system 200 according to an embodiment of the present invention. In one embodiment, computer system 200 can be used to implement computing device 102 of FIG. 1. As shown in FIG. 2, computer system 200 can include one or more processors 202 that communicate with a number of peripheral devices via a bus subsystem 204. These peripheral devices can include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computer system 200 communicate with each other as intended. Although bus subsystem 204 is shown schematically as a single bus, alternative embodiments of the bus subsystem can utilize multiple buses.

Network interface subsystem 216 can serve as an interface for communicating data between computer system 200 and other computer systems or networks. Embodiments of network interface subsystem 216 can include, e.g., an Ethernet card, a Wi-Fi and/or cellular adapter, a modem (telephone, satellite, cable, ISDN, etc.), digital subscriber line (DSL) units, and/or the like.

User interface input devices 212 can include a keyboard, pointing devices (e.g., mouse, trackball, touchpad, etc.), a scanner, a barcode scanner, a touch-screen incorporated into a display, audio input devices (e.g., voice recognition systems, microphones, etc.) and other types of input devices. In general, use of the term “input device” is intended to include all possible types of devices and mechanisms for inputting information into computer system 200.

User interface output devices 214 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 200.

Storage subsystem 206 can include a memory subsystem 208 and a file/disk storage subsystem 210. Subsystems 208 and 210 represent non-transitory computer-readable storage media that can store program code and/or data that provide the functionality of embodiments of the present invention.

Memory subsystem 208 can include a number of memories including a main random access memory (RAM) 218 for storage of instructions and data during program execution, and a read-only memory (ROM) 220 in which fixed instructions are stored. File storage subsystem 210 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 200 is illustrative and not intended to limit embodiments of the present invention. Many other configurations having more or fewer components than system 200 are possible.

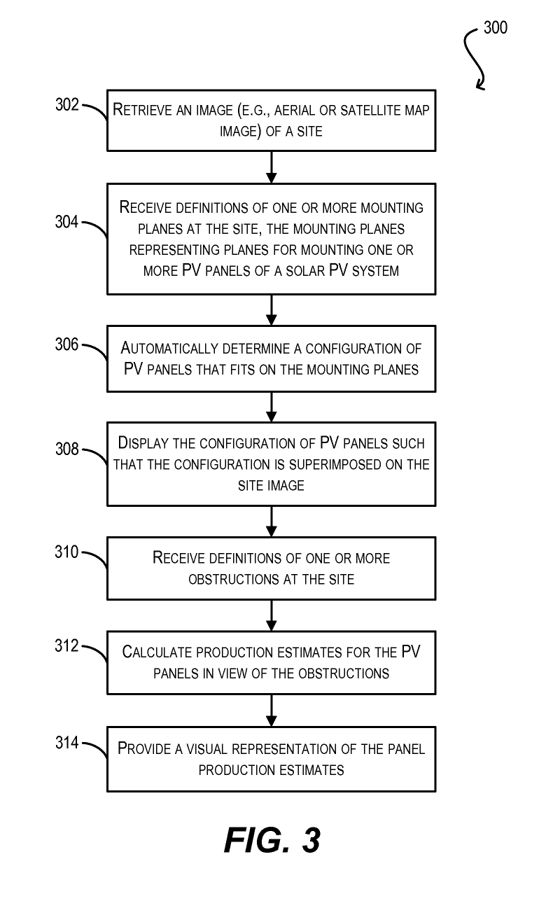

FIG. 3 illustrates a process 300 that can be carried out by PV design module 106 of FIG. 1 for facilitating the design of a PV system according to an embodiment of the present invention. At block 302, PV design module 106 can retrieve an image of a site where a PV system is to be installed. The retrieved image can be, e.g., a satellite image, aerial image, or any other type of image that is usable for delineating mounting planes for PV panels at the site. In one embodiment, the image can be retrieved from a publically accessible mapping website or service (e.g., mapping services 110 of FIG. 1), such as Google Maps, Bing Maps, or the like. Once retrieved, the image can be displayed in the context of 3D design program 104 to a user.

At block 304, PV design module 106 can receive, from the user, definitions of one or more mounting planes for mounting PV panels at the site. For example, if the site is a residence or building, the user can draw, on top of the displayed site image, a polygon (via, e.g., a series of points/lines) outlining a roof surface of the residence or building. The user can also specify other properties of the mounting planes, such as pitch, setbacks, and so on.

At block 306, PV design module 106 can automatically determine a configuration (e.g., number, layout) of PV panels that fit within the boundaries of the mounting planes defined at block 304. In certain embodiments, this process can include determining the actual area of each mounting plane in view of the heading and elevation at which the site image was originally taken. For example, if the site image is an aerial image that was taken at a 45 degree angle, the area of the polygon drawn by the user at block 304 would be larger than the actual area of the roof surface underlying the polygon. PV design module 106 can take this into account and determine what the actual area of the mounting plane should be.

Once the PV panel configuration is determined, PV design module 106 can display the panel configuration on top of (i.e., superimposed on) the site image in 3D design program 104 (block 308). In this manner, the user can easily visualize how the site will look post-installation (i.e., with the PV panels installed).

In some cases, it may be useful for the user to quickly estimate the yearly PV energy production for the PV panel configuration determined at block 306. To this end, PV design module 106 can receive, from the user, definitions of one or more obstructions at the site (block 310). These obstructions can include, e.g., trees, buildings, or any other structures that could possibly shade the PV panels at the site, and thus adversely affect their energy production. In one embodiment, these obstructions can be defined or selected as 3D objects within 3D design program 104. Alternatively, these obstructions can be retrieved from an external data source.

At block 312, PV design module 106 can calculate production estimates for the PV panels in the determined panel configuration in relation to the location that the PV panels are placed and in view of the obstructions defined at block 310. This process can include, e.g., calculating a sun exposure value for each PV panel and calculating an estimated yearly production value for each PV panel.

Once the production estimates have been generated, PV design module 106 can provide a visual representation of the estimates in 3D design program 104 (block 314). In one embodiment, this can comprise color-coding the panel configuration superimposed on the site image such that the color of each PV panel indicates its estimated production value. Other types of visual representations (e.g., pattern coding, etc.) are also possible and would be apparent to one of ordinary skill in the art.

Additional details regarding the processing performed at the various blocks of FIG. 3, along with other features and advantages of the present invention, are provided in the sections below.

### Retrieving Site Image

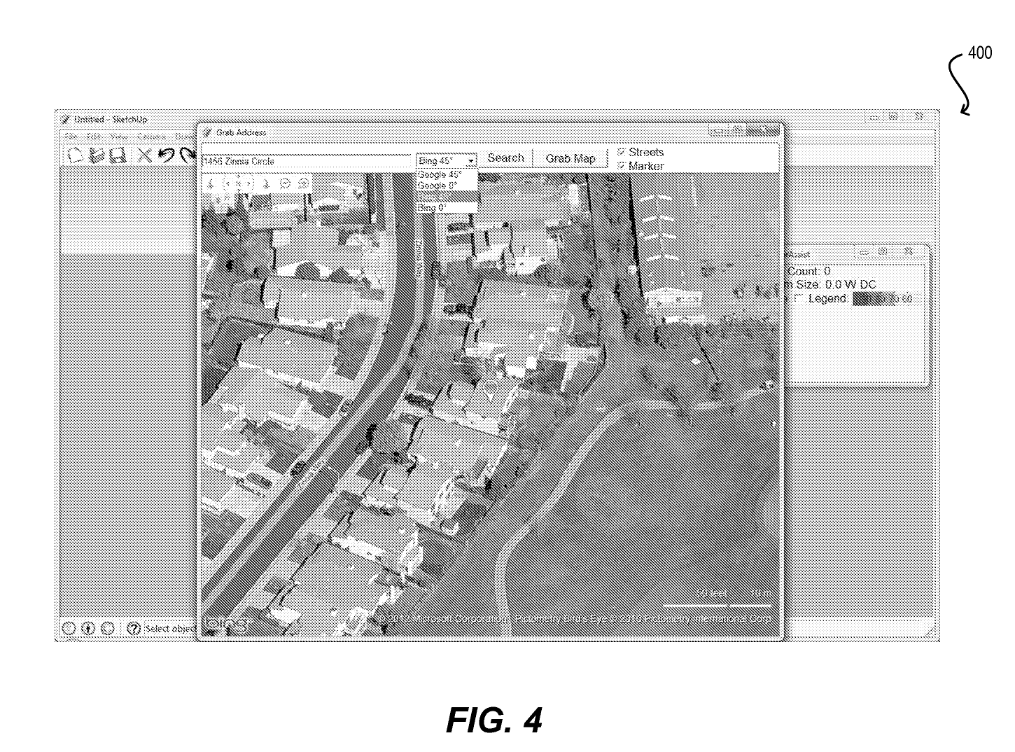

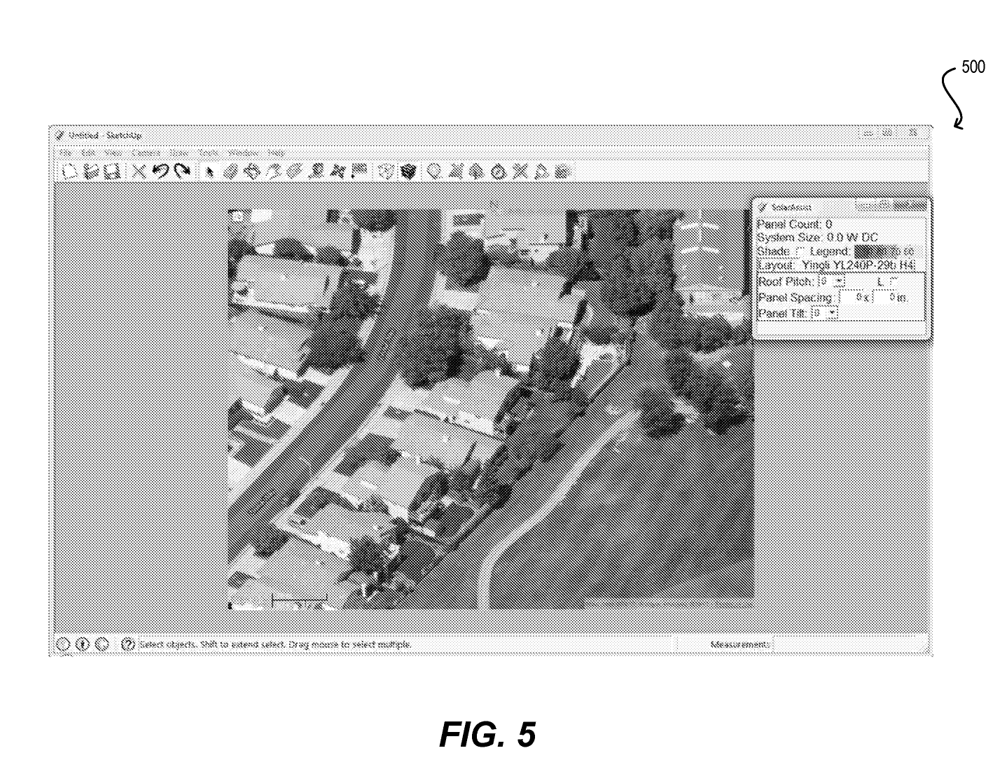

As described with respect to block 302 of FIG. 3, PV design module 106 is configured to initially retrieve an image (e.g., satellite, aerial, etc.) of a site where a PV system is to be installed. In a particular embodiment, this can be carried out by generating and presenting a “grab address” user interface, such as user interface 400 of FIG. 4. As shown in FIG. 4, user interface 400 includes, inter alia, input fields for entering a site address and specifying a source mapping service and image type (e.g., Bing 45 degrees, Google 45 degrees, etc.). In response to receiving a particular address, PV design module 106 can access the specified mapping service and retrieve an image of the address location. The retrieved image can then be displayed in a main window of 3D design program 104 (e.g., window 500 of FIG. 5).

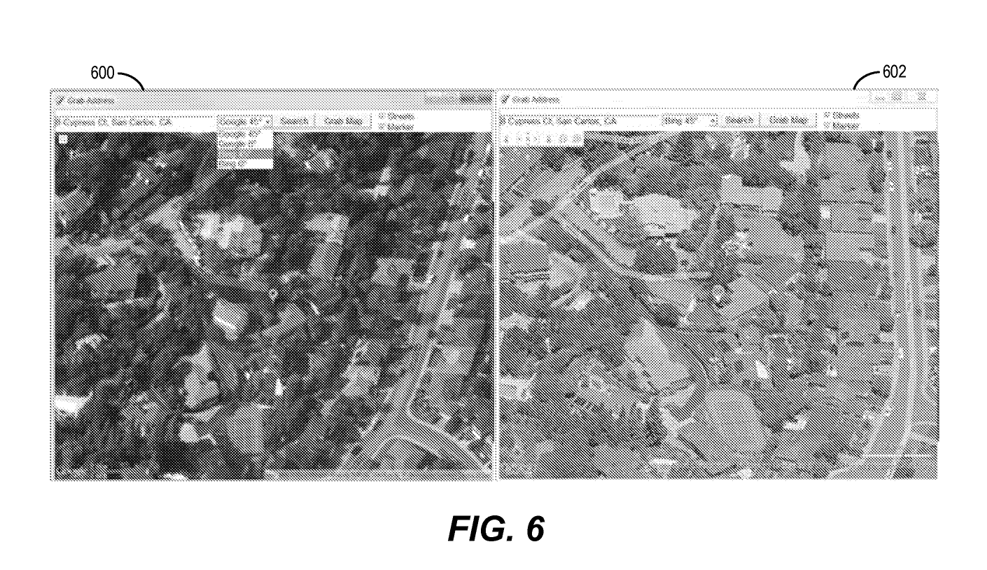

For some locations, the quality of the images provided by different mapping services may vary significantly in quality. Since it is beneficial for PV design module 106 to work with the highest quality image possible, PV design module 106 can provide a feature for retrieving images for a single site/address from multiple, different mapping services and displaying the images simultaneously (e.g., side by side). An example of this is shown in FIG. 6, which depicts a first image 600 for an address as retrieved from Google Maps (45 degree view), and a second image 602 for the same address as retrieved from Bing Maps (45 degree view). With this feature, the user can easily compare the quality of the images provided by different mapping services and select the highest quality image for further use by PV design module 106.

In alternative embodiments, PV design module 106 can provide a facility for importing the site image (in various image formats) into program 104. In addition, PV design module 106 can give a user the ability to use blueprints or designs of houses for PV panel design.

### Determining PV Panel Configuration

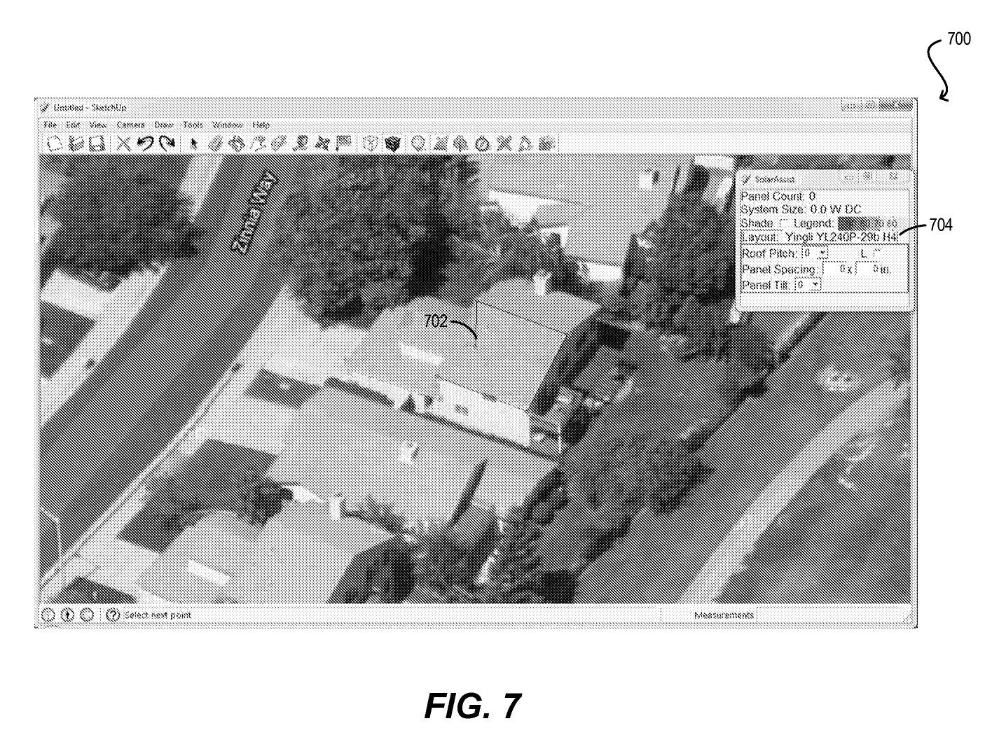

Per block 304 of FIG. 3, once an image of an installation site has been retrieved, PV design module 106 can receive definitions of one or more mounting planes for mounting PV panels at the site. In a particular embodiment, the mounting plane definitions can correspond to one or more polygons that is drawn as a series of points or lines on top of the site image within 3D design program 104. FIG. 7 is an example user interface 700 that illustrates such a polygon 702 being drawn on the site image retrieved in FIGS. 4 and 5. User interface 700 also includes various fields for entering additional mounting plane/panel information, such as panel type, roof pitch, panel spacing, panel tilt, and so on. In alternative embodiments, the mounting plane definitions can be obtained from a predefined dataset, such as an XML document comprising a roof design for the installation site.

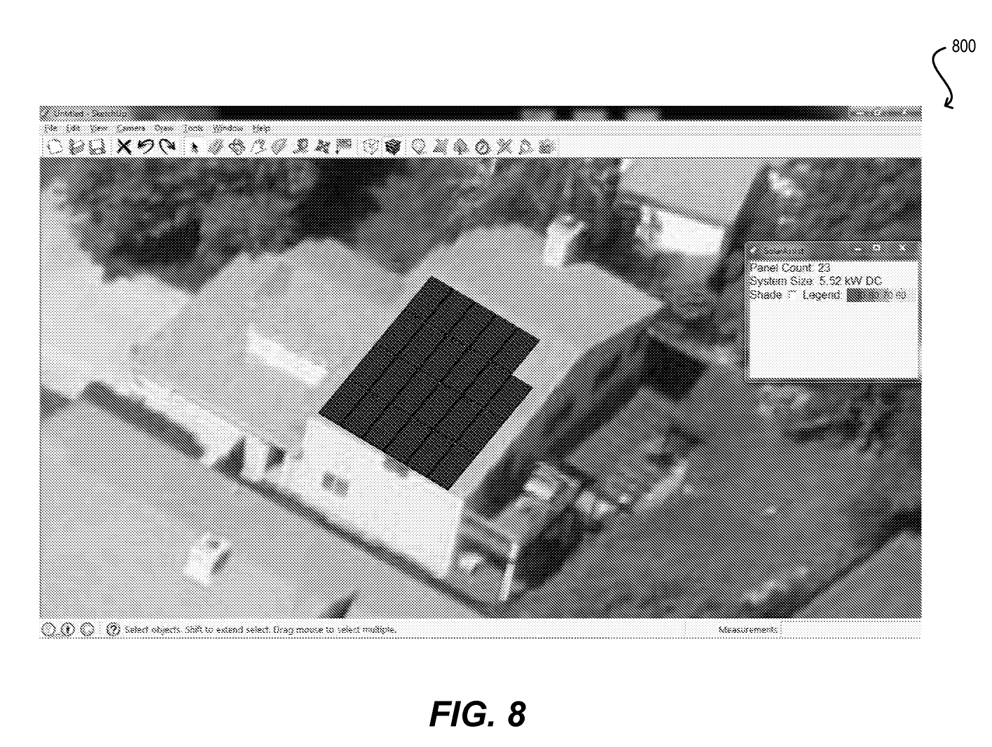

After the mounting plane definitions have been received, PV design module 106 can determine a configuration of PV panels that fits within the boundaries of the user-defined mounting planes, and can subsequently display the determined panel configuration on top of (i.e., superimposed on) the site image (see blocks 306 and 308 of FIG. 3). FIG. 8 is an example user interface 800 that depicts the mounting plane of FIG. 7 after it has been populated with PV panels per the processing of block 306 of FIG. 3. As shown, the panel configuration is superimposed directly on top of the site image, thereby providing the user a visual mockup of the final, installed system.

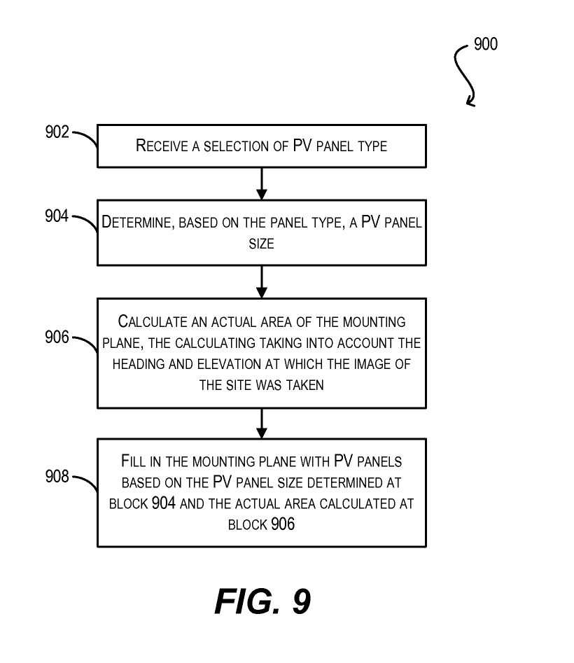

In some embodiments, due to the angle/elevation at which the original site image was taken, the polygon that is drawn by the user on top of the site image may not reflect the actual area of the mounting surface beneath the polygon. For instance, in FIG. 7, the area of polygon 702 will not necessarily reflect the actual area of the roof surface beneath polygon 702. In these embodiments, PV design module 106 can carry out a process for automatically detecting and accounting for this discrepancy when determining the PV panel configuration. FIG. 9 illustrates such a process 900 that can be performed by PV design module 106 in the context of block 306 of FIG. 3.

At blocks 902 and 904, PV design module 106 can receive a selection of PV panel type and determine, based on the type, a PV panel size. For instance, the PV panel type can be selected by the user via field 704 of FIG. 7.

At block 906, PV design module 106 can calculate an actual area for the mounting plane underlying the polygon drawn by the user. The calculating can take into account the heading and elevation at which the original site image was taken, as well as the slope and azimuth of the polygon. The effect of this calculation is to transform the user-drawn 2D polygon into a 3D plane that is a representation of the mounting plane in the 2D image as it would appear in 3D. In embodiments where the original site image is taken at a 45 degree view, the user-drawn polygon will typically be resized to be smaller. In embodiments, where the original site image is taken via a satellite (i.e., 0 degree view), the user-drawn polygon will typically be resized to be larger.

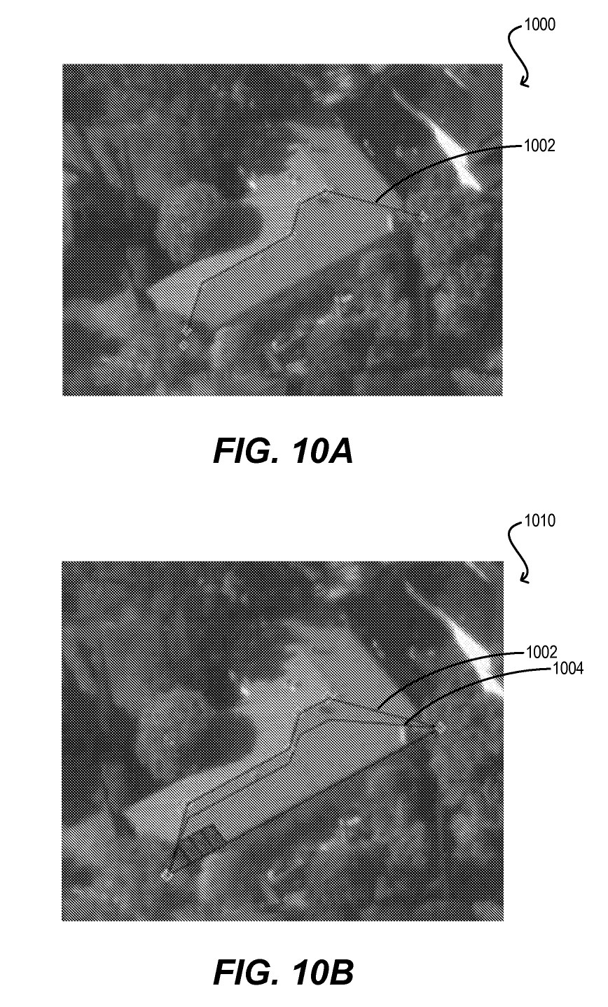

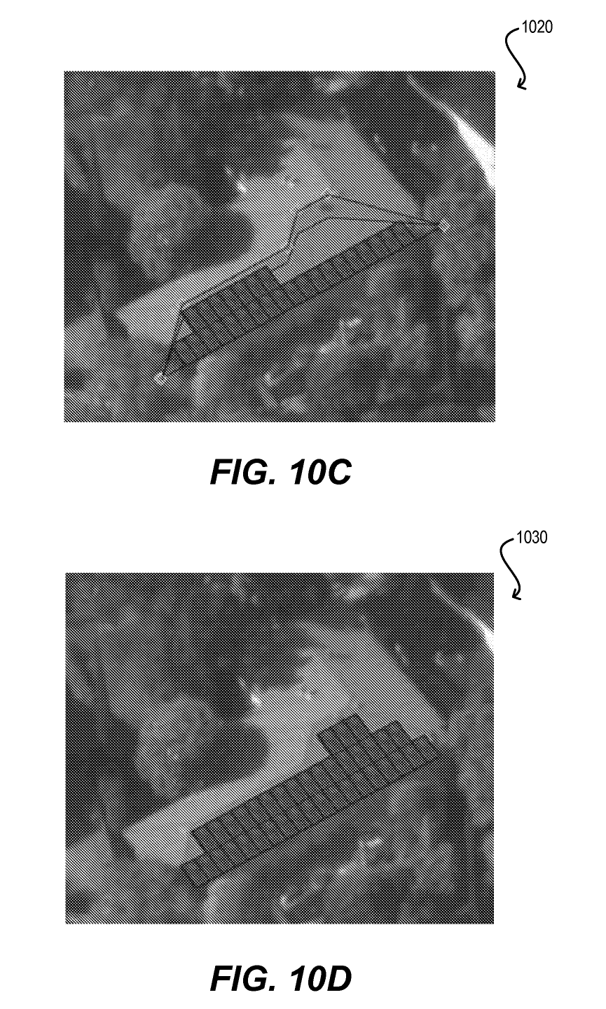

At block 908, PV design module 106 can fill in the mounting planes with PV panels based on the PV panel size determined at block 904 and the actual area of the mounting plane calculated at block 906. FIGS. 10A-10D are images 1000-1030 that visually illustrate this processing. In image 1000, a user-drawn polygon 1002 is shown overlaid on a roof of a residence. In image 1010, an actual area 1004 is calculated, which reflects the actual area of the roof surface under polygon 1002. Further, PV design module 106 begins the process of filling in PV panels within actual area 1004. In images 1020 and 1030, PV design module 106 continues filling in panels until no further panels will fit within area 1004.

### Automated Panel Stringing and PV Inverter Selection

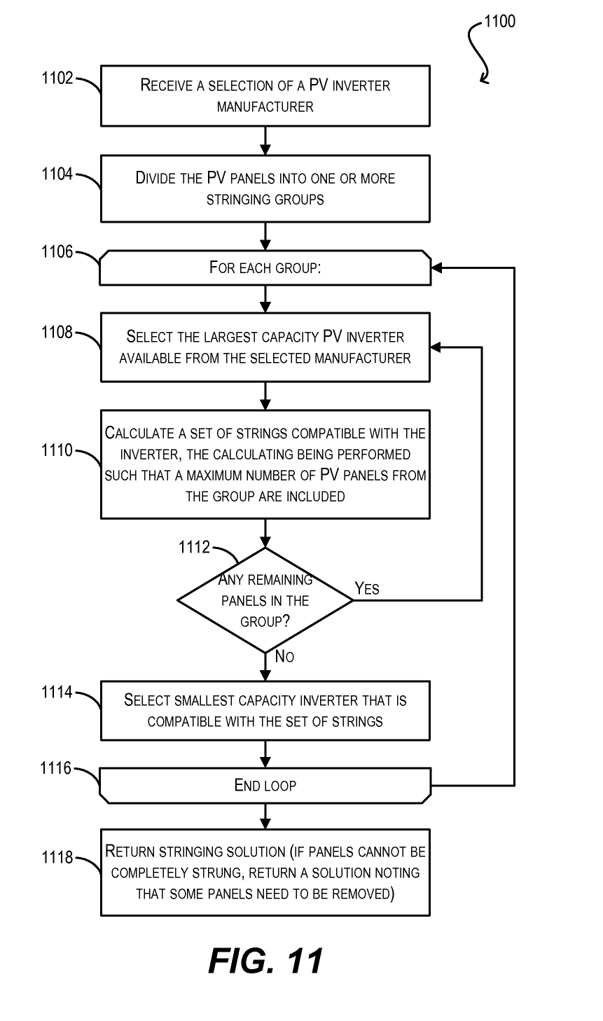

In addition to automatically determining a PV panel configuration for an installation site, PV design module 106 can also automatically determine an optimal stringing solution for the panel configuration and associate each string with an appropriate PV inverter. This stringing and PV inverter determination can be recalculated any time there is a panel count change (due to, e.g., resizing of the mounting plane polygon or the manual addition/removal of panels). FIG. 11 illustrates a process 1100 for carrying out this processing according to an embodiment of the present invention. Process 1100 assumes that a PV panel type has already been selected for the installation site via, e.g., field 704 of FIG. 7.

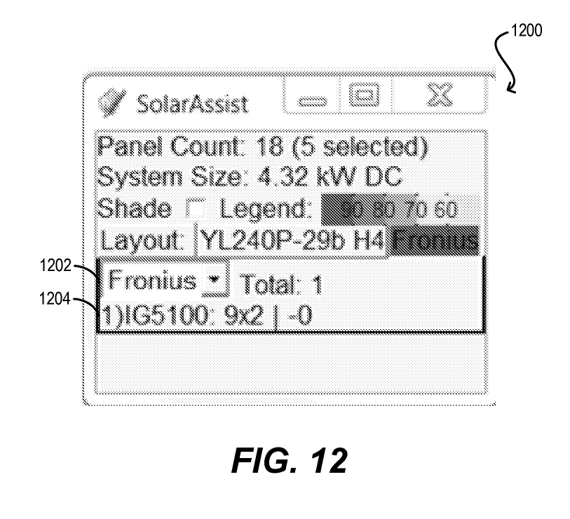

At block 1102, PV design module 106 can receive a selection of a particular PV inverter manufacturer. This selection can be received from a user via an input field exposed by module 106 or 3D design program 104, such as field 1202 shown in the “SolarAssist” window 1200 of FIG. 12.

At block 1104, PV design module 106 can divide the PV panels determined at block 306 of FIG. 3 into one or more stringing groups, where the panels in each group are capable of being stringed together. In one embodiment, the panels in a given group can share the same tilt and azimuth.

Once the PV inverter manufacturer has been selected and the stringing groups have been determined, PV design module 106 can enter a loop for each stringing group (block 1106). At block 1108 within the loop, PV design module 106 can select the largest capacity PV inverter that is available from the selected manufacturer. This can comprise accessing a list of inverters from an external database, such as PV component database 112 of FIG. 1, and selecting the largest capacity inverter from the list. In one embodiment, this list can include all of the inverter models sold by the selected manufacturer. In other embodiments, this list can include only those inverter models that are available in the supply chain for immediate purchase and installation at the installation site.

At block 1110 within the loop, PV design module 106 can calculate a set of strings compatible with the inverter, such that a maximum number of panels from the current stringing group are included in the string set. This calculating can take into account various possible string lengths in view of the panel and inverter specifications. For example, the string length calculations can be based on the PV inverter's maximum input power (in DC watts) and panel output power (summation of panel voltages in the string). Further, these power specifications can be qualified by the average temperature at the installation site (which affects power output), as well as the efficiency of the inverter and panels.

In a particular embodiment, the string length calculations performed at block 1110 can further take into account how shade will typically fall on the panel configuration. Generally speaking, PV panels in a string are connected in series; if one of the panels in the string is shaded, current cannot flow through that panel (thereby affecting the power output of the entire string). Similarly, each individual PV panel is composed of a plurality of solar cells that are connected in series; if one or more cells in a panel are shaded, that can affect the power output of the entire panel. PV design module 106 can take these string-level and panel-level characteristics into consideration when determining how the PV panels of the system should be strung. For example, in one embodiment, PV design module 106 can string together panels that are affected by a certain shade region into a first string, and panels that are not affected by the shade region into a second string. In this manner, one shaded panel will not adversely affect an entire string. This shading information can be generated by performing a shading analysis of the PV panel configuration, which is described further below.

After determining a set of strings for the current inverter at block 1110, PV design module 106 can check whether there are any remaining panels in the current stringing group (block 1112). If so, control can return to block 1108. If there are no more panels in the current stringing group, module 108 can attempt to find a smaller capacity inverter from the selected manufacturer that is still compatible with the string set determined at block 1110 (block 1114). In this manner, module 106 can ensure that the inverter is properly sized for the string. Blocks 1108 through 1114 can then be repeated for the remaining stringing groups per loop 1106.

Once all of the stringing groups for the panel configuration have been processed, loop 1106 can end (block 1116) and PV design module 106 can return a stringing solution (block 1118). This stringing solution will typically be expressed as a set of string lengths that are associated with one or more PV inverters. For instance, field 1204 of FIG. 12 shows a solution in which a configuration of 18 Yingli PV panels have been strung as two strings of 9 panels each. Further, each string is associated with one Fronius IGS 5100 inverter. In this example, there are no leftover panels (all of the panels in the configuration have been strung). In embodiments where one or more panels cannot be strung, PV design module 106 can automatically remove those panels from the configuration, or provide an indication to the user that those panels should be removed.

### Defining Obstructions

As described with respect to block 310 of FIG. 3, in certain embodiments PV design module 106 can allow a user to define obstructions around an installation site. These obstructions represent structures (e.g., trees, buildings, etc.) that can potentially shade the PV panels determined at block 306 of FIG. 3. Once defined, PV design module 106 can use these obstructions to estimate the amount of shade each PV panel receives throughout a year, which in turn can be used to estimate the yearly PV energy production for each panel.

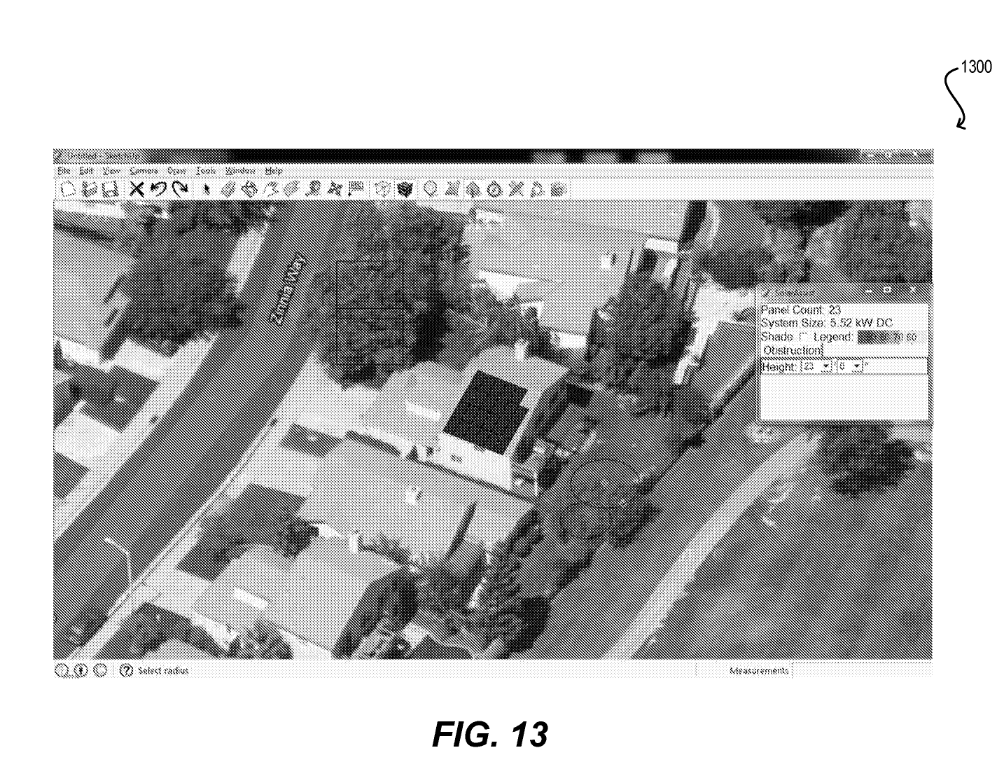

In one embodiment, the obstructions can be manually defined by the user within 3D design program 104 by placing various geometric primitives (e.g., cones, cylinders, etc.) around the installation site. FIG. 13 is an example user interface 1300 that shows such primitives being placed around a residential installation. This approach enables the user to quickly provide rough estimates of the shape and volume of obstructions. For example, a cone can be used to represent a tree, a cuboid can be used to represent a building, and so on.

In alternative embodiments, the obstructions can be defined by selecting one or more predefined 3D models from a 3D object library. This 3D object library may provide models that apply to all installation locations, or may be customized to provide models corresponding to the region in which a particular installation site is located. For example, if the installation site is located in the northern US, the 3D object library may contain 3D models for various types of coniferous trees. On the other hand, if the installation site is located in the southern United States, the 3D object library may include 3D models for various types of tropical trees. By using such predefined models, the shape and volume of the obstructions can be more accurately estimated, which is beneficial for calculating shading estimates via a raytracing approach as described below. In one embodiment, the predefined 3D models can be retrieved from an external data source, such as other sources 114 of FIG. 1.

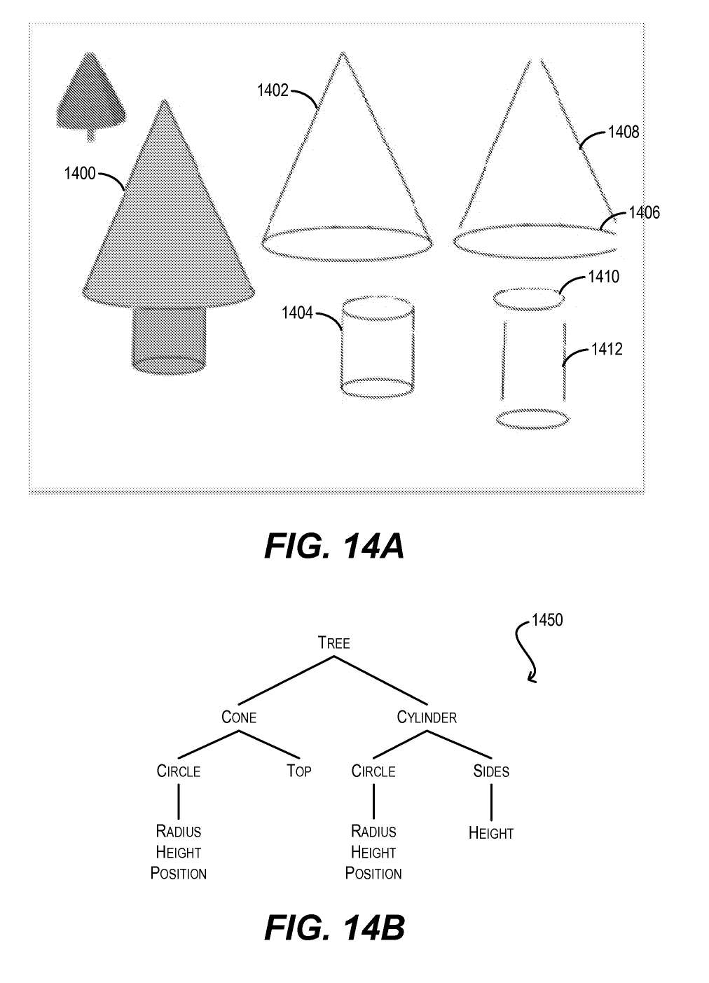

In certain embodiments, each 3D model in the 3D object library can be designed and stored parametrically as a hierarchical series of 2D and/or 3D sub-objects. For example, FIG. 14A illustrates an example tree model 1400 that is composed of a cone 1402 and a cylinder 1404. Cone 1402 is further composed of a circle 1406 and a top 1408, while cylinder 1404 is further composed of circles 1410 and sides 1412. FIG. 14B illustrates a hierarchical representation 1450 of the components of tree model 1400. This approach reduces the amount of space needed to store the 3D models, as each model can simply include references to other models or primitives. It also promotes model reuse, as existing models can be easily combined into more complex composite models.

When selecting/importing predefined 3D objects into 3D design program 104 for placing obstructions around the installation site, a user may also import a 3D model of the site itself (e.g., a 3D model of a home) if such a model is available. This allows the site and its surrounding obstructions to be displayed in a visually cohesive manner within program 104.

### Calculating and Displaying Production Estimates

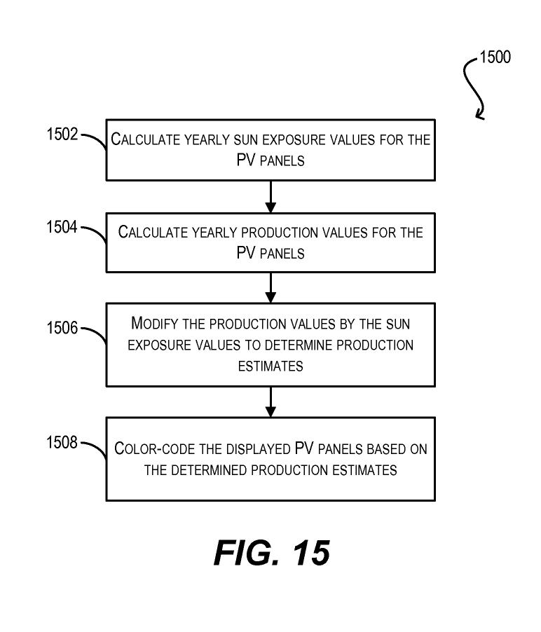

Once obstructions have been placed around an installation site, PV design module 106 can estimate the PV energy production of the PV panels relative to the site and provide a visual representation of the estimates within 3D design program 104 (see blocks 312 and 314 of FIG. 3). FIG. 15 illustrates a process 1500 that can be performed by PV design module 106 for calculating and presenting these estimates according to an embodiment of the present invention.

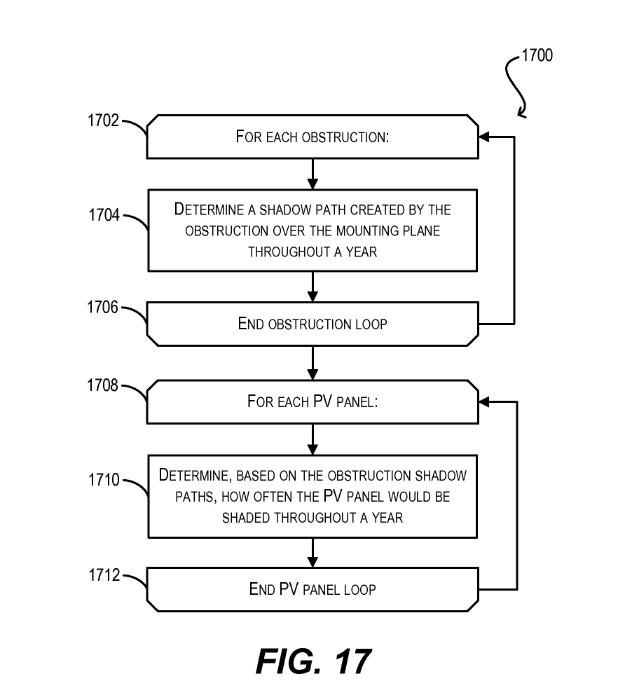

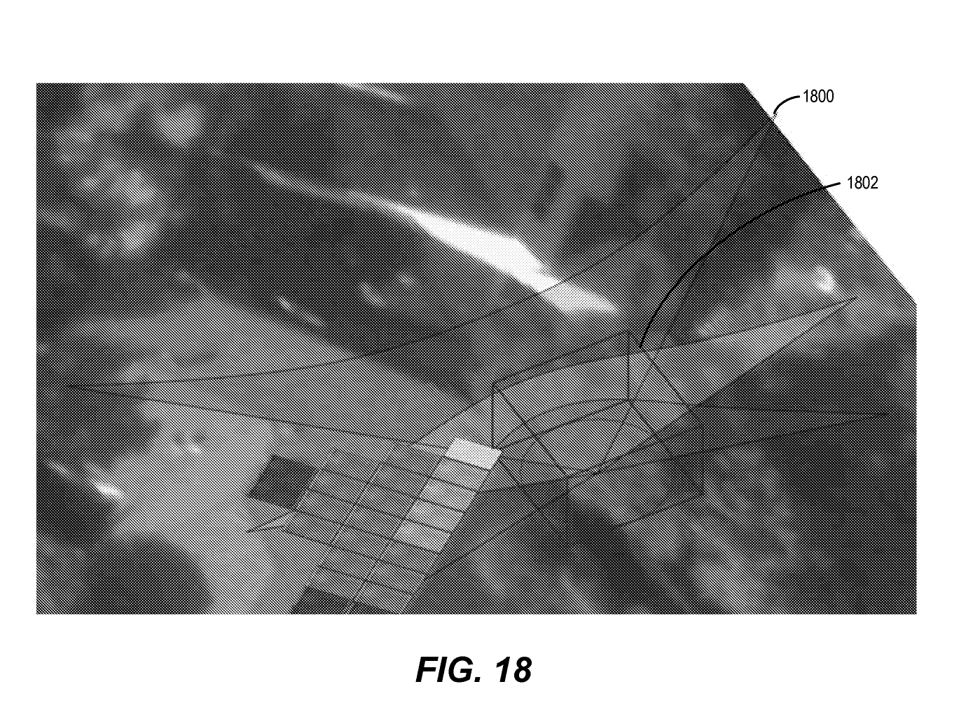

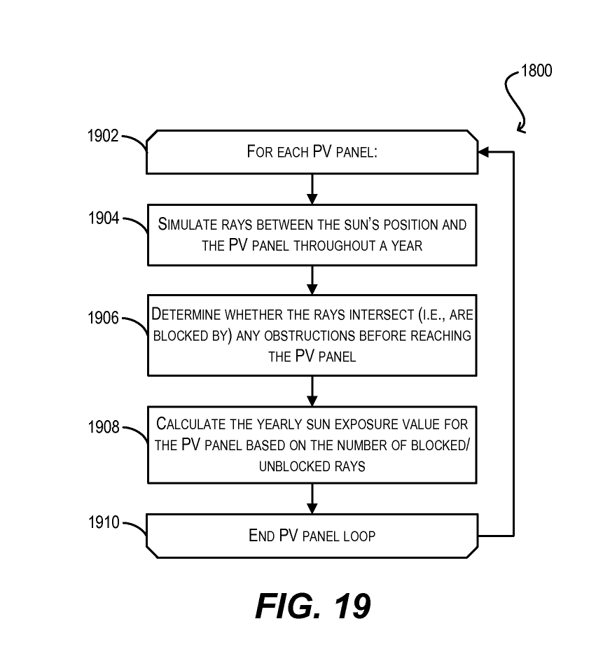

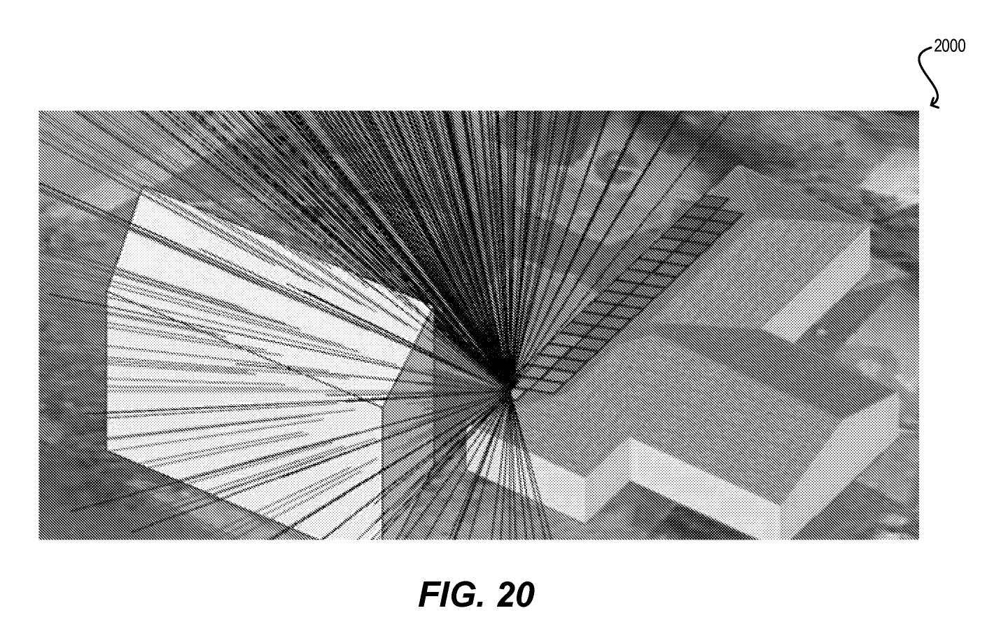

At block 1502, PV design module 106 can calculate yearly sun exposure values for the PV panels determined at block 306 of FIG. 3. These yearly sun exposure values can represent estimates of how often each PV panel will be shaded throughout a year. In one embodiment, the yearly sun exposure values can be calculated by determining shadow paths for each obstruction defined at block 310 of FIG. 3, and then determining per panel shading based on those shadow paths. This approach is described in further detail with respect to FIGS. 17 and 18 below. In another embodiment, the yearly sun exposure values can be calculated via a raytracing algorithm. The raytracing algorithm can simulate, for each PV panel or for each PV cell within a panel/module, sun rays/vectors that will be received by the panel, or blocked due to an obstruction, over the course of a year. The yearly sun exposure of the panel can then be calculated based on those sun rays/vectors. This approach is described in further detail with respect to FIGS. 19 and 20 below.

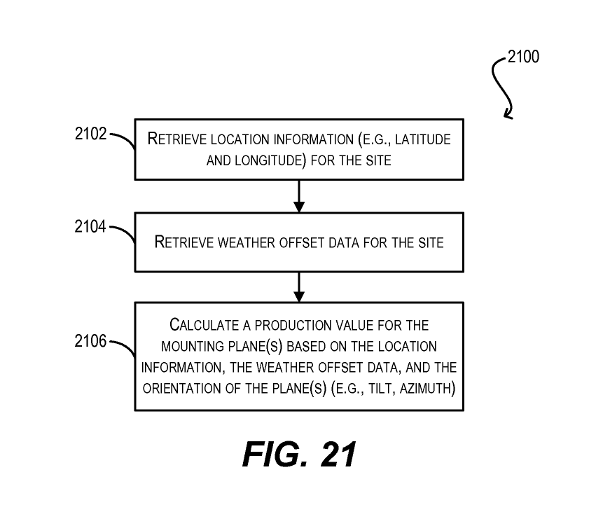

At block 1504, PV design module 106 can estimate production values for the PV panels over a period of time (e.g., a year). These estimated production values can represent how much PV energy each PV panel will produce over time. In one embodiment, the production values can be calculated by referencing a historical sun exposure database, such as PVWatts. In alternative embodiments, the production values can be calculated via an algorithm that takes into account various attributes of the PV panel configuration and the site location, such as panel type, latitude/longitude, azimuth, and tilt/pitch of the mounting plane. This algorithm is described in further detail with respect to FIG. 21 below.

At block 1506, PV design module 106 can modify the yearly production values calculated at block 1504 by the yearly sun exposure values calculated at block 1502 to determine production estimates for the PV panels. For example, if the yearly production value for a particular panel (absent any shading) is 60 kWh/year, but the yearly sun exposure value for the panel is only 50%, the production estimate for the panel may be calculated as 60×0.5, which equals 30 kWh/year. Other methods for calculating production estimates based on sun exposure values and production values are also possible.

In certain embodiments, the yearly production estimates can be further refined by incorporating the shade data for each cell for each 15 minute increment and an electrical model (represented as diodes and resistors) of the modules and strings to calculate the output at each 15 minute interval, which can be summed across the year to estimate total annual production.

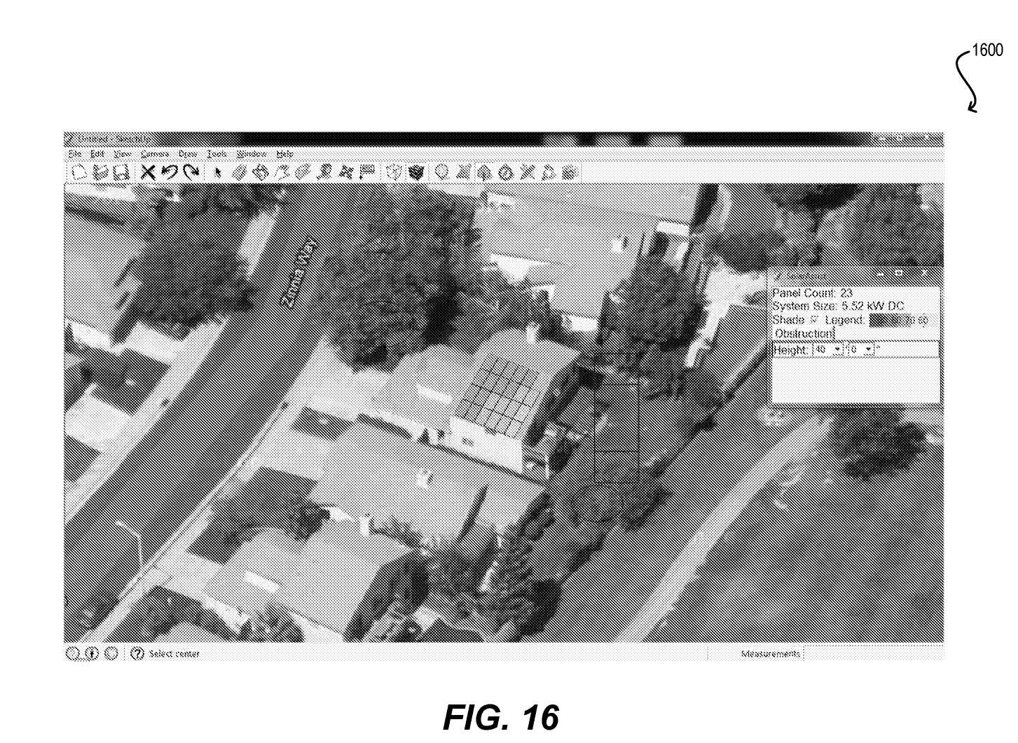

Once the production estimates have been calculated, PV design module 106 can color-code the PV panels to reflect the production estimate for each panel (block 1508). FIG. 16 is an example graphical user interface 1600 that displays such color-coding in the context of 3D design program 104.

As noted with respect to block 1502, the yearly sun exposure values for a PV panel configuration can be calculated via various algorithms, such as a shadow path-based algorithm or a raytracing algorithm. FIG. 17 illustrates a process 1700 for carrying out a shadow path-based algorithm according to an embodiment of the present invention. Process 1700 can be executed each time an obstruction is added/removed by the user, or each time the panel mounting plane is changed.

At blocks 1702 through 1706, PV design module 106 can determine, for each obstruction defined at block 310 of FIG. 3, a shadow path created by the obstruction over the mounting plane throughout a year. FIG. 18 illustrates an example shadow path 1800 determined for an obstruction 1802. The various colored areas of path 1800 correspond to different shadow regions cast by obstruction 1802 at different times during a year. For example, the red area corresponds to a shadow region cast during the winter solstice, the yellow area corresponds to a shadow region cast during the spring equinox, and the green area corresponds to a shadow region cast during the summer solstice. PV design module 106 can calculate further shadow regions beyond what is shown in FIG. 18.

Returning to FIG. 17, at block 1708 through 1712, PV design module 106 can determine, for each PV panel on the mounting plane, how often the PV panel would be shaded throughout a year based on the shadow paths calculated at block 1704. This can comprise evaluating the shadow path for each obstruction in view of the panel, and then aggregating the total amount of “shading time” caused by the obstructions to arrive at a yearly sun exposure value for the panel. Since this calculation is performed on a per panel, per obstruction basis, the total running time will increase significantly as the number of obstructions defined by the user increases.

In contrast to the shadow path-based algorithm of FIG. 17, FIG. 19 illustrates a process 1900 for carrying out a raytracing-based shading algorithm according to an embodiment of the present invention.

At block 1902, PV design module 106 can enter a loop for each PV panel in the panel configuration. At block 1904, PV design module 106 can simulate rays/vectors between the sun's position and the panel through a year. FIG. 20 illustrates what these rays/vectors would look like for a particular panel.

At block 1906, PV design module 106 can determine whether any of the rays intersect (i.e., are blocked by) any user-defined obstructions before reaching the panel. For example, in FIG. 20, the red-colored rays are determined to intersect an obstruction, and thus are unable to reach the panel. In one embodiment, the processing at this step can take into account the potential growth of certain obstructions over time (e.g., growth of a tree, or leaves falling off of a deciduous tree in the winter), which can allow for an accurate shading analysis over periods of time longer than one year (e.g., 15 or 20 years, which is the typical useful lifetime of a PV system).

At block 1908, PV design module 106 can calculate the yearly sun exposure value for the panel based on the number of blocked/unblocked rays determined at blocks 1904 and 1906. The flow can then return to block 1904 and repeat until all of the PV panels have been processed (block 1910). Since process 1900 does not require calculations to be performed on a per obstruction basis, this algorithm may be preferable to the algorithm of FIG. 17 in instances where a large number of user-defined obstructions have been placed around the installation site.

In certain embodiments, process 1900 may be modified such that sun rays/vectors are only calculated for specific times throughout a year. These rays can then be weighted according to a predefined dataset and used to calculate TSRF (total solar resource fraction) values. These TSRF values represent the fraction of energy a particular collector (e.g., panel) would receive when compared to one in the same city, but that has optimal tilt, orientation, and no external shading. For example, a collector with a TSRF of 80 indicates that 80% of the solar energy at the collector's location over a year will be available to the collector. These TSRF values can serve as a proxy for the sun exposure values described at block 1908.

FIG. 21 illustrates a process 2100 for calculating yearly PV energy production values for a PV panel configuration per block 1506 of FIG. 15. Typically, such production values are estimated based on historical sun exposure data provided by publically accessible databases such as PVWatts. Process 2100 provides a method for estimating these values based on attributes of the system and the site location, without requiring any historical data.

At block 2102, PV design module 106 can retrieve location information, such as latitude and longitude, for the installation site. In one embodiment, this information may be provided by the mapping service (e.g., mapping services 110 of FIG. 1) that provided the image of the site at block 302 of FIG. 3, or may be retrieved from another external data source.

At block 2104, PV design module 106 can retrieve weather offset data for the site. This weather offset data may be retrieved from, e.g., a Wban station that is close to the site location.

Finally, at block 2106, PV design module 106 can calculate a production value for the panel configuration/mounting plane based on the location information, the weather offset data, and various parameters pertaining to the orientation of the mounting plane and panels(e.g., tilt, pitch, azimuth). In a particular embodiment, the production value can be calculated using the following series of equations:

Tilt=tilt+pitch

lat_tilt=(tilt−latitude+offset) to radians

az_tilt=(tilt) to radians

Production %=cos(lat_tilt)−sin(az_tilt)*|azimuth−180|−((90−latitude)/2)/(90−latitude)/4.5

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
retrieving, by a computer system, an image of a site;
receiving, by the computer system from a user, a definition of a mounting plane at the site, the mounting plane representing a plane for mounting one or more photovoltaic (PV) panels of a solar PV system;
automatically determining, by the computer system, a configuration of PV panels that fits on the mounting plane; and
displaying, by the computer system, the configuration of PV panels such that the configuration is superimposed on the image.

2. The method of claim 1 wherein the image of the site is a satellite or aerial image.

3. The method of claim 1 wherein retrieving the image of the site comprises:
retrieving a first image of the site from a first web-based mapping service;
retrieving a second image of the site from a second web-based mapping service;
displaying, to the user, the first and the second image; and
receiving, from the user, a selection of the first image or the second image.

4. The method of claim 1 wherein the definition of the mounting plane includes a plurality of points defining a polygon, the polygon having been drawn on the image by the user.

5. The method of claim 4 wherein the site is a residence or building, the polygon having been drawn on a roof surface of the residence or building.

6. The method of claim 1 wherein automatically determining the configuration of PV panels that fits on the mounting plane comprises:
receiving, from the user, a selection of a PV panel type;
determining, based on the selected PV panel type, a PV panel size;
calculating an actual area of the mounting plane, the calculating taking into account the heading and elevation at which the image of the site was taken; and
filling in the mounting plane with PV panels based on the PV panel size and the actual area of the mounting plane.

7. The method of claim 1 further comprising, subsequently to automatically determining the configuration of PV panels, automatically calculating a stringing solution for the PV panels.

8. The method of claim 7 wherein automatically calculating the stringing solution comprises:
receiving, from the user, a selection of a PV inverter manufacturer;
dividing the PV panels into one or more groups; and
for each group:
selecting the largest capacity PV inverter available from the PV inverter manufacturer;
calculating a set of strings compatible with the inverter, the calculating being performed such that a maximum number of PV panels from the group are included;
if, subsequently to calculating the set of strings, there are no remaining PV panels in the group that are not in the set of strings:
selecting a smaller capacity PV inverter available from the PV inverter manufacturer; and
determining whether the set of strings is compatible with the smaller capacity PV inverter;
else if, subsequently to calculating the set of strings, there are remaining PV panels in the group that are not in the set of strings, repeating the selecting and calculating for the remaining PV panels.

9. The method of claim 8 wherein calculating the set of strings comprises:
performing a string-level shading analysis and a panel-level shading analysis; and
calculating the set of strings based on the string-level and panel-level shading analyses.

10. The method of claim 1 further comprising:
receiving, from the user, definitions of one or more obstructions at the site;
calculating production estimates for the PV panels in the configuration of PV panels in view of the one or more obstructions; and
providing a visual representation of the production estimates.

11. The method of claim 10 wherein providing a visual representation of the production estimates comprises color-coding the PV panels based on the production estimates.

12. The method of claim 10 wherein the one or more obstructions are predefined three-dimensional (3D) objects selected from a 3D object library.

13. The method of claim 12 wherein each 3D object in the 3D object library is stored as cascading series of three-dimensional or two-dimensional objects.

14. The method of claim 10 wherein calculating production estimates for the PV panels comprises:
calculating sun exposure values for the PV panels;
calculating production values for the PV panels; and
modifying the production values by the sun exposure values to determine the production estimates.

15. The method of claim 14 wherein calculating the sun exposure values comprises:
for each obstruction in the one or more obstructions, determining a shadow path created by the obstruction over the mounting plane throughout a year; and
for each PV panel, determining, based on the shadow paths, how often the PV panel would be shaded throughout the year.

16. The method of claim 14 wherein calculating the sun exposure values comprises, for each PV panel:
simulating rays between the sun's position and the PV panel throughout a year;
determining whether the rays are blocked by any obstructions before reaching the PV panel; and
calculating the sun exposure value for the PV panel based on the number of blocked and unblocked rays.

17. The method of claim 14 wherein calculating the sun exposure values comprises, for each PV panel:
simulating rays between the sun's position and the PV panel over a period of time; and
calculating a Total Solar Resource Fraction (TSRF) value for the PV panel based on the rays;
and calculating a sun exposure value for the PV panel based on the TSRF value.

18. The method of claim 14 wherein the production values are calculated without using any historical production data.

19. A computer-readable storage medium having stored thereon program code executable by a computer system, the program code comprising:
code that causes the computer system to retrieve an image of a site;
code that causes the computer system to receive, from a user, a definition of a mounting plane at the site, the mounting plane representing a plane for mounting one or more PV panels of a solar PV system;
code that causes the computer system to automatically determine a configuration of PV panels that fits on the mounting plane; and
code that causes the computer system to display the configuration of PV panels such that the configuration is superimposed on the image.

20. A system comprising:
a processor configured to:
retrieve an image of a site;
receive, from a user, a definition of a mounting plane at the site, the mounting plane representing a plane for mounting one or more PV panels of a solar PV system;
automatically determine a configuration of PV panels that fits on the mounting plane; and
display the configuration of PV panels such that the configuration is superimposed on the image.
